(19) United States
(12) Patent Application Publication
(10) Pub. No.: US 2003/0109410 A1
(43) Pub. Date: Jun. 12, 2003

(54) Aqueous surfactant-containing cleaner with improved drying behavior for cleaning hard surfaces

(75) Inventors: Werner Hahnel, Essen (DE); Karin Mohr, Bad Soden Salmunster (DE); Felix Muller, Velbert (DE); Jorg Peggau, Essen (DE)

Correspondence Address: SCULLY SCOTT MURPHY & PRESSER, PC, 400 GARDEN CITY PLAZA, GARDEN CITY, NY, 11530

(73) Assignee: Goldschmidt AG, Essen (DE)

(21) Appl. No.: 10/278,145

(22) Filed: Oct. 22, 2002

(30) Foreign Application Priority Data
Oct. 26, 2001 (DE) 101 53 047.1

(51) Int. Cl. C11D 17/00

(52) U.S. Cl. 510/426; 510/427; 510/499

(57) ABSTRACT

The invention provides surfactant combinations comprising:

(a) one or more alkyl ether sulfates;

(b) at least one amphoteric interface-active glycine compound of the general formula (I)

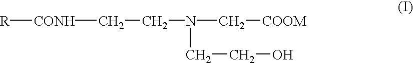

in which

R is an alkyl radical of a natural or synthetic monobasic fatty acid or a fatty acid mixture having 5 to 21, preferably 7 to 17, carbon atoms, which may optionally be branched and may optionally contain multiple bonds, and

M may be hydrogen, ammonium, alkali metal or alkaline earth metal; and optionally

(c) 0 to 50% of one or more alkyl and/or aryl sulfonates;

(d) 0 to 15% of one or more alkyl sulfates; and/or

(e) 0 to 20% of one or more amphoteric surfactants.

### FIELD OF THE INVENTION

The present invention relates to an aqueous surfactant-containing cleaner which exhibits an improved drying behavior for cleaning hard surfaces, in particular dishes.

### BACKGROUND OF THE INVENTION

Consumers make particular demands on aqueous surfactant-containing cleaners, in particular manual dishwashing detergents, especially in regard to their cleaning action, and tolerability by the skin, as well as their esthetic aspects.

Specifically, aqueous cleaners have to be formulated with surfactants as well as cleaning auxiliaries and additives which ensure complete removal of all contaminating residues from the surfaces. Nowadays, the foregoing property is taken for granted by consumers as well as the skin-friendly properties of such aqueous cleaners.

In addition, there is also a requirement for employing dishwashing detergents which are simple and easy to use. Thus, for example, the manual drying of wet cleaned glassware, of wet crockery or cutlery using absorbent cloths is regarded by the users as tiresome additional work.

Although leaving the cleaned and wet surfaces to dry in air involves less work, it takes longer and thus delays clearing away of the washed article. A further requirement by the users is that the dishwashing detergents employed should be capable of improving the drying times.

In addition, and especially in the case of gleaming (shiny, reflecting) hard surfaces, for example, made of glass, porcelain, ceramic, polymeric or metallic materials, the operation of cleaning and drying regularly leads to the formation of undesired visible residues, such as marks (water marks) or streaks, and also to a loss in shine or dull appearance.

As the cleaned item is removed from the wash liquor, the liquid which remains on the surface initially runs off slowly until its layer on the surface has become so thin that the liquor no longer runs off, but only reduces further as a result of evaporation (dries). The residues emulsified or dissolved in the liquid drops then produce streaks or marks.

A further essential requirement of dishwashing detergents is that the cleaned and dried surfaces must not, for esthetic reasons, have any visible streaks or water marks.

WO 96/18717 A1 discloses a skin-friendly, liquid, aqueous cleaner for hard surfaces in the form of a clear microemulsion which removes grease and/or bathroom soiling, and leaves behind a gleaming appearance on surfaces which are not rinsed. This prior art cleaner comprises 14 to 24% by weight of an alkali metal salt of a C₁₂-C₁₈-paraffin sulfonate; 2 to 6% by weight of an alkali metal salt of an ethoxylated C₁₂-C₁₈-alkyl ether sulfate; 2 to 8% by weight of a betaine surfactant; a nonionic surfactant; at least one solubility promoter; a cosurfactant; and a water-insoluble hydrocarbon, perfume or essential oil. A disadvantage of the liquid cleaner disclosed in WO 96/18717 A1 is the unfavorable drying behavior of such compositions.

In view of the state of the art mentioned above, there is a continued need for providing surfactant-containing cleaners that are useful for cleaning hard surfaces which overcome the above disadvantages. Moreover, there is a need for providing surfactant-containing cleaners which exhibit improved run-off and drying behavior as well as high cleaning action and good residue behavior.

### SUMMARY OF THE INVENTION

An object of the present invention is to significantly improve the drying and run-off behavior of aqueous surfactant-containing solutions for cleaning hard surfaces, in particular to accelerate the drying or the run-off.

According to the present invention, the foregoing object is achieved by a surfactant combination which comprises:

(a) one or more alkyl ether sulfates;

(b) at least one amphoteric interface-active glycine compound of general formula (I)

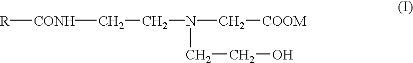

in which

R is an alkyl radical of a natural or synthetic monobasic fatty acid or a fatty acid mixture having 5 to 21, preferably 7 to 17, carbon atoms, which may optionally be branched and may optionally contain multiple bonds, and

M is hydrogen, ammonium, alkali metal or alkaline earth metal; and optionally

(c) 0 to 50% of one or more alkyl- and/or arylsulfonates;

(d) 0 to 15% of one or more alkyl sulfates; and/or

(e) 0 to 20% of one or more amphoteric surfactants.

According to the present invention, the inventive surfactant combination may be a constituent of an aqueous, liquid composition.

The present invention further provides an aqueous, liquid composition which comprises the following components:

(a) one or more alkyl ether sulfates;

(b) at least one amphoteric interface-active glycine compound of general formula (I);

and optionally

(c) 0 to 50% of one or more alkyl- and/or arylsulfonates;

(d) 0 to 15% of one or more alkyl sulfates; and/or

(e) 0 to 20% of one or more betaines and/or amphoteric surfactants;

and water.

The amount of water present in the inventive aqueous, liquid composition is sufficient to form a composition whose sum of components adds up to 100%.

### DETAILED DESCRIPTION OF THE INVENTION

Surprisingly, it has now been found that the addition of an amphoteric interface-active glycine compound of general formula (I) to surfactant combinations or corresponding compositions contributes considerably to an improvement in the drying and run-off behavior, as well as in the residue behavior (reduced streaking and marking). These improvements are obtainable without effecting the cleaning action of the surfactants.

The surfactant combination according to the present invention is generally suitable as a cleaner for hard surfaces and the inventive surfacant combination can also be used as a hand dishwashing detergent.

In this regard, the amphoteric surfactants, and particularly the alkyl ether sulfates, contribute primarily to the cleaning action. The amphoteric interface-active glycine compounds of general formula (I) have, in addition to the alkyl sulfonates, arylsulfonates, and/or alkyl sulfates and, in particular the betaines and amphoteric surfactants, an extremely positive effect on the drying and run-off behavior, i.e., the amphoteric interface-active glycine compounds markedly increase the run-off rate and thus reduce residue formation.

The present invention also relates to the use of a composition according to the present invention for cleaning hard surfaces, in particular dishes. Preferably, the composition according to the present invention is used for the manual cleaning of hard surfaces, more preferably for the manual cleaning of dishes. Suitable hard surfaces include, but are not limited to: dishes, glassware, cutlery, and all other hard surfaces, in particular those made of polymeric or metallic materials which are found in many home products as well as commercial products.

The main advantage of the present invention is that the drying and run-off behavior is significantly improved. This improvement in drying and run-off is believed to be a result of the co-use of the amphoteric interface-active glycine compounds of general formula (I). More specifically, the improvement of the present invention is manifested in the high drying rate or short drying time, the high run-off rate or short run-off time, and the low residue formation and the retained shine which is observed using the inventive composition. In this regard, drying is to be understood as meaning both overall drying and drying after run-off. The term ‘overall drying’ denotes drying which is continued until moisture is no longer detectable (either by visual means or by touch) on the hard surface.

A further advantage of the present invention is that the inventve composition retains high cleaning action, specifically in the case of greasy soilings.

In the following description, some of the substances used in the present invention, which also serve as ingredients of cosmetic compositions, are referred, where appropriate, in accordance with the International Nomenclature for Cosmetic Ingredients (INCI Nomenclature). The INCI names are given in the “International Cosmetic Ingredient Dictionary and Handbook, Seventh Edition (1997)”, which is published by The Cosmetic, Toiletry and Fragrance Association (CTFA), 1101, 17th Street NW, Suite 300, Washington, D.C. 20036, U.S.A.

In the present application, the information CAS means that the subsequent numerical sequence is a designation by the Chemical Abstracts Service.

Unless explicitly stated otherwise, the amounts given in percentages by weight (% by weight) refer to the total surfactant combination or the total composition.

In the present invention, the term amphoteric interface-active glycine compounds refers to compounds of general formula (I)

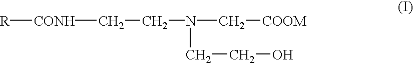

in which

R is an alkyl radical of a natural or synthetic monobasic fatty acid or a fatty acid mixture having 5 to 21, preferably 7 to 17, carbon atoms, which may optionally be branched and may optionally contain multiple bonds, and

M is hydrogen, ammonium, alkali metal or alkaline earth metal.

These compounds are commercially available products, the preparation of which is the subject-matter of a large number of patents and general specialist publications. See, for example, U.S. Pat. No. 2,781,354, U.S. Pat. No. 2,961,451, U.S. Pat. No. 3,231,580, U.S. Pat. No. 3,408,361, U.S. Pat. No. 3,941,817, U.S. Pat. No. 4,705,893; EP-A-0 269 940, EP-A-0 647 469; H. Hoffmann, Seifen-Öle-Fette-Wachse, 95, 3 [1969]; H. Hein, Fette-Seifen-Anstrichmittel, 448 [1978]; and U. Ploog, Fette-Seifen-Anstrichsmittel, 154 [1979].

In formula I of the present invention, suitable radicals R are even-numbered and odd-numbered, saturated and unsaturated, branched and unbranched alkyl radicals, preferably fatty acid alkyl radicals, e.g., caproic acid alkyl, caprylic acid alkyl, capric acid alkyl, lauric acid alkyl, myristic acid alkyl, palmitic acid alkyl, stearic acid alkyl, arachidic acid alkyl, behenic acid alkyl, lignoceric acid alkyl, cerotic acid alkyl, valeric acid alkyl, oenanthic acid alkyl, pelargonic acid alkyl, pentadecanoic acid alkyl, margaric acid alkyl, pristanic acid alkyl, phytanic acid alkyl, oleic acid alkyl, erucic acid alkyl, nervonic acid alkyl, linoleic acid alkyl, linolenic acid alkyl, arachidonic acid alkyl, eicosapentanoic acid alkyl, docosahexenoic acid alkyl, oleic acid alkyl, palmitoleic acid alkyl, myristoleic acid alkyl, elaidic acid alkyl, linolelaidic acid alkyl, eleostearic acid alkyl or parinaric acid alkyl.

Particular preference is given in the present invention to the glycine compound N-coconut fatty acid-amidoethyl-N-hydroxyethylglycinate (REWOTERIC® AM C), which contains only small amounts of undesired diamides as a result of the process.

The one or more glycine compounds of formula I are used in the present invention in an amount of from 0.01 to 10% by weight, preferably 0.05 to 7% by weight, more preferably 0.05 to 5% by weight, even more preferably 0.1 to 3% by weight, and most preferably in an amount of from 0.2 to 2% by weight.

To achieve the effect according to the present invention, the glycine compound can be used on its own, or in combination with one or more betaines and/or amphoteric surfactants. The combination of the glycine compounds with betaines and/or amphoteric surfactants provides a surprisingly synergistic effect.

According to the present invention, preference is therefore given to using combinations of the glycine compounds of formula I and betaines and/or amphoteric surfactants.

The ratio of the amphoteric interface-active glycine compound to amphoteric surfactantsis in the range from 0.9:0.1 to 0.1:0.9, preferably 0.4:0.6 to 0.2:0.8.

Surfactants

The composition according to the present invention comprises surfactants in a total amount of about 0.5 to 60% by weight, preferably 1 to 55% by weight, more preferably 5 to 50% by weight, even more preferably 10 to 45% by weight, and most preferably 12 to 40% by weight. Highly preferred amounts are, for example, 18, 25, 32 and/or 36% by weight.

In addition to alkyl ether sulfates, alkyl- and/or arylsulfonates, alkyl sulfates and/or amphoteric surfactants, the composition according to the present invention can, in particular to improve the cleaning action, run-off behavior and/or drying behavior, further comprise one or more additional anionic surfactants, nonionic surfactants and/or cationic surfactants.

The alkyl ether sulfates, alkyl- and/or arylsulfonates and/or alkyl sulfates, and the additional anionic surfactants are usually used as alkali metal salts, alkaline earth metal salts and/or mono-, di- or trialkanolammonium salts. The anionic surfactants may also be in the form of their corresponding acid to be neutralized in situ with the appropriate alkali metal hydroxide, alkaline earth metal hydroxide and/or mono-, di- or trialkanolamine. Preference is given in the present invention to the alkali metals potassium and, in particular, sodium, to the alkaline earth metals calcium and, in particular, magnesium, and to the alkanolamines mono-, di- or triethanolamine. Particular preference is given in the present invention to the sodium salts.

Alkyl Ether Sulfates

Alkyl ether sulfates (fatty alcohol ether sulfates, INCI Alkyl Ether Sulfates) are products of sulfation reactions with alkoxylated alcohols. In this regard, a person skilled in the art generally understands alkoxylated alcohols as the reaction products of alkylene oxide, preferably ethylene oxide, with alcohols. For the purposes of the present invention, the alcohols are preferably longer-chain alcohols, i.e., with aliphatic straight-chain or mono- or multibranched, acyclic or cyclic, saturated or mono- or polyunsaturated, preferably straight-chain, acyclic, saturated alcohols having 6 to 22, preferably 8 to 18, more preferably 10 to 16 and most preferably 12 to 14, carbon atoms. n Moles of ethylene oxide and one mole of alcohol generally give, depending on the reaction conditions, a complex mixture of addition products of differing degrees of ethoxylation (n=1 to 30, preferably 0.3 to 20, in particular 0.3 to 10, particularly preferably 0.3 to 5). A further embodiment of the alkoxylation includes the use of mixtures of alkylene oxides, preferably the mixture of ethylene oxide and propylene oxide. In a highly preferred embodiment of the present invention, fatty alcohols with low degrees of ethoxylation are employed. Specifically, it is preferred that fatty alcohols having 0.3 to 4 ethylene oxide units (EO), in particular 0.3 to 2 EO, for example 0.5 EO, 1.0 EO, 1.3 EO and/or 2.0 EO, such as Na C₁₂-C₁₄-fatty alcohol+0.5 EO sulfate, Na C₁₂-C₁₄-fatty alcohol+1.3 EO sulfate, Na C₁₂-C₁₄-fatty alcohol+2.0 EO sulfate and/or Mg C₁₁-C₁₄-fatty alcohol+1.0 EO sulfate be employed in the present invention.

The composition according to the present invention comprises one or more alkyl ether sulfates in an amount of about 1 to 50% by weight, preferably 3 to 40% by weight, more preferably greater than 6 to 30% by weight, even more preferably 8 to 20% by weight, and most preferably 10 to 16% by weight.

Alkyl- and/or Arylsulfonates

The alkylsulfonates (INCI Sulfonic Acids) typically have an aliphatic straight-chain or mono- or multibranched, acyclic or cyclic, saturated or mono- or polyunsaturated, preferably branched, acyclic, saturated, alkyl radical having 6 to 22, preferably 9 to 20, more preferably 11 to 18 and most preferably 13 to 17, carbon atoms.

Suitable alkylsulfonates include, but are not limited to: saturated alkanesulfonates, unsaturated olefmsulfonates and ether sulfonates—which can be derived formally from the alkoxylated alcohols which also form the basis of the alkyl ether sulfates—for which a distinction is made between terminal ether sulfonates (n-ether sulfonates) with sulfonate function bonded to the polyether chain, and internal ether sulfonates (i-ether sulfonates) with sulfonate function linked to the alkyl radical.

According to the present invention, preference is given to alkanesulfonates, in particular alkanesulfonates with a branched, preferably secondary, alkyl radical, for example, the secondary alkanesulfonate sec-Na C₁₃₋₁₇-alkanesulfonate (INCI Sodium C₁₄₋₁₇ Alkyl Sec Sulfonate).

Preferred arylsulfonates are alkylbenzenesulfonates, where the alkyl radicals are branched and unbranched chains having C₁-C₂₀, preferably C₂-C₁₈, more preferably C₆-C₁₆, and most preferably C₈-C₁₂. Particularly preferred examples include: linear alkylbenzenesulfonates (LAS) and/or cumenesulfonate.

The composition according to the present invention comprises one or more alkyl- and/or arylsulfonates in an amount of about 0.1 to less than 50% by weight, preferably 0.1 to 30% by weight, more preferably 1 to less than 14% by weight, even more preferably 2 to 10% by weight, and most preferably 4 to 8% by weight.

Alkyl Sulfates

In the present invention, it is also possible to use alkyl sulfates, such as, for example, fatty alcohol sulfates. Suitable alkyl sulfates are sulfates of saturated and unsaturated fatty alcohols having C₆-C₂₂, preferably C₁₀-C₁₈, and most preferably C₁₂-C₁₆. Particularly suitable alkyl sulfates are those with native carbon cut C₁₂₋₁₄₋₁₆ and/or petrochemical carbon cut C₁₂₋₁₃/C₁₄₋₁₅ in the range from 0 to 15%, preferably 0-10%, particularly preferably 0-8%.

Amphoteric Surfactants

The amphoteric surfactants (zwitterionic surfactants) which can be used in the present invention include: betaines, alkylamidoalkylamines, alkyl-substituted amino acids, acylated amino acids and biosurfactants. Of the foregoing amphoteric surfactants, betaines are highly preferred in the present invention.

The inventive composition comprises one or more amphoteric surfactants in an amount of about 0.1 to 20% by weight, preferably 1 to 15% by weight, more preferably 2 to 12% by weight, even more preferably 3 to 10% by weight, and most preferably 4 to 8% by weight.

Betaines

Suitable betaines include: alkylbetaines, alkylamidobetaines, imidazoliniumbetaines, sulfobetaines (INCI Sultaines) and phosphobetaines and preferably satisfy formula (II),

R¹—[CO—X—(CH₂)ₙ]ₓ—N⁺(R²)(R³)—(CH₂)ₘ—[CH(OH)—CH₂]_{y}—Y⁻ (II)

in which

R¹ is a saturated or unsaturated C₈-C₂₂-alkyl radical, preferably C₈-C₁₈-alkyl radical, in particular a saturated C₁₀-C₁₆-alkyl radical, for example, a saturated C₁₂-C₁₄-alkyl radical,

X is —NH—, —NR₄— with the C₁-C₄-alkyl radical R⁴, O or S,

n is a number from 1 to 10, preferably 2 to 5, in particular 3,

x is 0 or 1, preferably 1,

R², R³, independently of one another, are a C₁-C₄-alkyl radical, optionally hydroxy-substituted, such as, for example, a hydroxyethyl radical, but in particular a methyl radical,

m is a number from 1 to 4, in particular 1, 2 or 3,

y is 0 or 1, and

Y is —COO⁻, —SO₃⁻, OPO(OR⁵)O or P(O)(O R⁵)O, where R⁵ is a hydrogen atom H or a C₁-C₄-alkyl radical.

The alkyl- and alkylamidobetaines of formula (II) with a carboxylate group (Y⁻═—COO⁻) are also called carbobetaines.

Preferred amphoteric surfactants employed in the present invention include alkylbetaines of formula (IIa), alkylamidobetaines of formula (IIb), sulfobetaines of formula (IIc) and amidosulfobetaines of formula (IId):

R¹—N⁺(CH₃)₂—CH₂COO⁻ (IIa)

R¹—CO—NH—(CH₂)₃—N⁺(CH₃)₂—CH₂COO⁻ (IIb)

R¹—N⁺(CH₃)₂—CH₂CH(OH)CH₂SO₃⁻ (IIc)

R¹—CO—NH—(CH₂)₃—N⁺(CH₃)₂—CH₂CH(OH)CH₂SO₃ (IIc)

(CH₃)₃—Si—O—[SiR(CH₃)—O]m-[Si(CH₃)₂—O]ₙ—Si(CH₃)₃ (IId)

(TEGOPREN® 6950)

in which R¹ has the same meaning as in formula II.

Particularly preferred amphoteric surfactants are carbobetaines, in particular carbobetaines of formulas (IIa) and (IIb), especially preferably alkylamidobetaines of formula (IIb).

Examples of suitable betaines and sulfobetaines include the following compounds which are named in accordance with INCI nomenclature: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coca-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kemelamidopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine. A preferred betaine is, for example, Cocamidopropyl Betaine, silicone betaine, such as, for example Dimethicone Propyl PG-Betaines, such as TEGOPREN® 6950.

Alkylamidoalkylamines

The alkylamidoalkylamines (INCI Alkylamido Alkylamines) are amphoteric surfactants of formula (III),

R⁹—CO—NR¹⁰—(CH₂)ᵢN(R¹¹)—(CH₂CH₂O)ⱼ—(CH₂)ₖ—[CH(OH)]ₗ—CH₂-Z-OM′ (III)

in which

R⁹ is a saturated or unsaturated C₆-C₂₂-alkyl radical, preferably C₈-C₁₈-alkyl radical, in particular a saturated C₁₀-C₁₆-alkyl radical, for example a saturated C₁₂-C₁₄-alkyl radical,

R¹⁰ is a hydrogen atom H or a C₁-C₄-alkyl radical, preferably H,

R¹¹ is a hydrogen atom H or CH₂COOM (for M see M′below),

i is a number from 1 to 10, preferably 2 to 5, in particular 2 or 3,

j is a number from 1 to 4, preferably 1 or 2, in particular 1,

k is a number from 0 to 4, preferably 0 or 1,

l is 0 or 1, where k=1, if I=1,

Z is —CO—, —SO₂—, —OPO(OR¹²)— or —P(O)(OR¹²)—, where R¹² is a C₁-C₄-alkyl radical or M (see below), and

M′ is a hydrogen, an alkali metal, an alkaline earth metal or a protonated alkanolamine, e.g., protonated mono-, di- or triethanolamine.

Preferred representatives satisfy formulas IIIa to IIId,

R⁹—CO—NH—(CH₂)₂—N(R¹¹)—CH₂CH₂O—CH₂—COOM (IIIa)

R⁹—CO—NH—(CH₂)₂—N(R¹¹)—CH₂CH₂O—CH₂CH₂—COOM (IIIb)

R⁹—CO—NH—(CH₂)₂—N(R¹¹)—CH₂CH₂O—CH₂(OH)CH₂—SO₃M (IIIc)

R⁹—CO—NH—(CH₂)₂N(R¹¹)—CH₂CH₂O—CH₂CH₂(OH)CH₂—OPO₃HM (IIId)

in which R¹¹ and M have the same meanings as in formula (III).

Exemplary alkylamidoalkylamines are the following mentioned compounds which are named in accordance with INCI nomenclature: Cocoamphodipropionic Acid, Cocobetainamido Amphopropionate, DEA-Cocoamphodipropionate, Disodium Caproamphodiacetate, Disodium Caproamphodipropionate, Disodium Capryloamphodiacetate, Disodium Capryloamphodipropionate, Disodium Cocoamphocarboxyethylhydroxypropylsulfonate, Disodium Cocoamphodiacetate, Disodium Cocoamphodipropionate, Disodium Isostearoamphodiacetate, Disodium Isostearoamphodipropionate, Disodium Laureth-5 Carboxyamphodiacetate, Disodium Lauroamphodiacetate, Disodium Lauroamphodipropionate, Disodium Oleoamphodipropionate, Disodium PPG-2-Isodeceth-7 Carboxyamphodiacetate, Disodium Stearoamphodiacetate, Disodium Tallowamphodiacetate, Disodium Wheatgermamphodiacetate, Lauroamphodipropionic Acid, Quaternium-85, Sodium Caproamphoacetate, Sodium Caproamphohydroxypropylsulfonate, Sodium Caproamphopropionate, Sodium Capryloamphoacetate, Sodium Capryloamphohydroxypropylsulfonate, Sodium Capryloamphopropionate, Sodium Cocoamphodiacetate, Sodium Cocoamphohydroxypropylsulfonate, Sodium Cocoamphopropionate, Sodium Coramphopropionate, Sodium Isostearoamphodiacetate, Sodium Isostearoamphopropionate, Sodium Lauroamphodiacetate, Sodium Lauroamphohydroxypropylsulfonate, Sodium Lauroampho PG-Acetate Phosphate, Sodium Lauroamphopropionate, Sodium Myristoamphodiacetate, Sodium Oleoamphodiacetate, Sodium Oleoamphohydroxypropylsulfonate, Sodium Oleoamphopropionate, Sodium Ricinoleoamphodiacetate, Sodium Stearoamphodiacetate, Sodium Stearoamphohydroxypropylsulfonate, Sodium Stearoamphopropionate, Sodium Tallamphopropionate, Sodium Tallowamphodiacetate, Sodium Undecylenoamphodiacetate, Sodium Undecylenoamphopropionate, Sodium Wheat Germamphodiacetate and Trisodium Lauroampho PG-Acetate Chloride Phosphate.

Alkyl-Substituted Amino Acids

Alkyl-substituted amino acids (INCI Alkyl-Substituted Amino Acids) preferred in the present invention are monoalkyl-substituted amino acids according to formula (IV),

R¹³—NH—CH(R¹⁴)—(CH₂)ᵤ—COOM′ (IV)

in which

R¹³ is a saturated or unsaturated C₆-C₂₂-alkyl radical, preferably C₈-C₁₈-alkyl radical, in particular a saturated C₁₀-C₁₆-alkyl radical, for example, a saturated C₁₂-C₁₄-alkyl radical,

R¹⁴ is a hydrogen atom H or a C₁-C₄-alkyl radical, preferably H,

u is a number from 0 to 4, preferably 0 or 1, in particular 1, and

M′ is a hydrogen, an alkali metal, an alkaline earth metal or a protonated alkanolamine, e.g., protonated mono-, di- or triethanolamine,

alkyl-substituted imino acids according to formula (V)

R¹⁵—N—[(CH₂)ᵥ—COOM″]₂ (V)

in which

R¹⁵ is a saturated or unsaturated C₆-C₂₂-alkyl radical, preferably C₈-C₁₈-alkyl radical, in particular a saturated C₁₀-C₁₆-alkyl radical, for example, a saturated C₁₂-C₁₄-alkyl radical,

v is a number from 1 to 5, preferably 2 or 3, in particular 2, and

M″ is a hydrogen, an alkali metal, an alkaline earth metal or a protonated alkanolamine, e.g., protonated mono-, di- or triethanolamine, where M″ in the two carboxyl groups may have the same or two different meanings, e.g., hydrogen and sodium or both sodium,

and mono- or dialkyl-substituted natural amino acids according to formula (VI),

R¹⁶—N(R¹⁷)—CH(R¹⁸)—COOM″ (VI)

in which

R¹⁶ is a saturated or unsaturated C₆-C₂₂-alkyl radical, preferably C₈-C₁₈-alkyl radical, in particular a saturated C₁₀-C₁₆-alkyl radical, for example, a saturated C₁₂-C₁₄-alkyl radical,

R¹⁷ is a hydrogen atom or a C₁-C₄-alkyl radical, optionally hydroxy- or amine-substituted, e.g., a methyl, ethyl, hydroxyethyl or aminopropyl radical,

R¹⁸ is the radical of one of the 20 natural α-amino acids H₂NCH(R₁₈)COOH, and

M′″ is a hydrogen, an alkali metal, an alkaline earth metal or a protonated alkanolamine, e.g., protonated mono-, di- or triethanolamine.

Particularly preferred alkyl-substituted amino acids are aminopropionates according to formula (VIa),

R¹³—NH—CH₂CH₂COOM′ (VIa)

in which R¹³ and M′″ have the same meanings as in formula (VI).

Exemplary alkyl-substituted amino acids that can be employed in the present invention include: Aminopropyl Laurylglutamine, Cocaminobutyric Acid, Cocaminopropionic Acid, DEA-Lauraminopropionate, Disodium Cocaminopropyl Iminodiacetate, Disodium Dicarboxyethyl Cocopropylenediamine, Disodium Lauriminodipropionate, Disodium Steariminodipropionate, Disodium Tallowiminodipropionate, Lauraminopropionic Acid, Lauryl Aminopropylglycine, Lauryl Diethylenediaminoglycine, Myristaminopropionic Acid, Sodium C₁₂-C₁₅ Alkoxypropyl Iminodipropionate, Sodium Cocaminopropionate, Sodium Lauraminopropionate, Sodium Lauriminodipropionate, Sodium Lauroyl Methylaminopropionate, TEA-Lauraminopropionate and TEA-Myristaminopropionate. Note that the above compounds are named in accordance with INCI nomenclature.

Acylated Amino Acids

Acylated amino acids are amino acids, in particular the 20 natural α-amino acids, which carry, on the amino nitrogen atom, the acyl radical R₁₉CO— of a saturated or unsaturated fatty acid R₁₉COOH—, where R₁₉ is a saturated or unsaturated C₆-C₂₂-alkyl radical, preferably C₈₋₁₈-alkyl radical, in particular a saturated C₁₀-C₁₆-alkyl radical, for example, a saturated C₁₂-C₁₄-alkyl radical. The acylated amino acids can also be used in the form of the alkali metal salt, alkaline earth metal salt or alkanolammonium salt, e.g., mono-, di- or triethanolammonium salt. Exemplary acylated amino acids are the acyl derivatives listed according to INCI under Amino Acids, e.g., Sodium Cocoyl Glutamate, Lauroyl Glutamic Acid, Capryloyl Glycine or Myristoyl Methylalanine.

Amphoteric Surfactant Combinations

In a particular embodiment of the present invention, a combination of at least one glycine compound of formula I with at least one amphoteric surfactant compound according to formulas II and/or III is used.

The amphoteric surfactant combination preferably comprises N-coconut fatty acid-amidoethyl-N-hydroxyethylglycinate (REWOTERIC®) AM C) and at least one additonal amphoteric surfactant, in particular, an alkylamidoalkylamine, preferably cocabetaine (IIa) and/or cocamidopropylbetaine (IIb).

In a further particular embodiment, the inventive composition comprises one or more amphoteric surfactants in an amount of more than 9% by weight. In yet another particular embodiment, the composition of the present invention comprises one or more amphoteric surfactants in an amount of less than 5% by weight.

Further Anionic Surfactants

The composition according to the present invention can further comprise one or more additional anionic surfactants, usually in an amount of from 0.001 to 5% by weight, preferably 0.01 to 4% by weight, more preferably 0.1 to 3% by weight, even more preferably 0.2 to 2% by weight, and most preferably 0.5 to 1.5% by weight, for example, 1% by weight, such as, for example, anionic sulfosuccinic acid surfactants. A detailed description of these known anionic surfactants is given by A. Domsch and B. Irrgang in Anionic surfactants: organic chemistry (edited by H. W. Stache; Surfactant science series; volume 56; ISBN 0-8247-9394-3; Marcel Dekker, Inc New York 1996, pp. 501-549).

The salts are preferably alkali metal salts, ammonium salts and mono-, di- or trialkanolammonium salts, for example, mono-, di- and triethanolammonium salts, in particular, lithium, sodium, potassium or ammonium salts, particularly preferably sodium or ammonium salts, especially preferably sodium salts.

Nonionic Surfactants

The composition according to the present invention can additionally comprise one or more nonionic surfactants, usually in an amount of from 0.001 to 5% by weight, preferably 0.01 to 4% by weight, more preferably 0.1 to 3% by weight, even more preferably 0.2 to 2% by weight, and most preferably 0.5 to 1.5% by weight, for example, 1% by weight.

For the purposes of the present invention, nonionic surfactants are polyglycol ethers, fatty acid alkanolamides and fatty acid polyglycol ethers. Important classes of nonionic surfactants according to the present invention are also amine oxides and the sugar surfactants, in particular the alkyl polyglucosides.

Amine oxides which may be employed in the present invention include: alkylamine oxides, in particular alkyldimethylamine oxides, alkylamidoamine oxides and alkoxyalkylamine oxides. Preferred amine oxides satisfy formulas (VII) and (VIIa)

R⁶R⁷R⁸N⁺—O⁻ (VII)

R⁶—[(O—NH—(CH₂)]_{z}—N+(R⁷)(R⁸)—O— (VIIa)

in which

R⁶ is a saturated or unsaturated C₆-C₂₂-alkyl radical, preferably C₈-C₁₈-alkyl radical, in particular a saturated C₁₀-C₁₆-alkyl radical, for example, a saturated C₁₂-C₁₄-alkyl radical, which is bonded to the nitrogen atom N in alkylamidoamine oxides of the formula (VIIa) via a carbonylamidoalkylene group —CO—NH—(CH₂)_{z}—, and in the alkoxyalkylamine oxides via an oxaalkylene groupe —O—(CH₂)_{z}—, where z is in each case a number from 1 to 1O, preferably 2 to 5, in particular 3, and

R⁷, R⁸, independently of one another, are a C₁-C₄-alkyl radical, optionally hydroxy-substituted such as, for example, a hydroxyethyl radical, in particular a methyl radical.

A preferred amine oxide is, for example, Cocamidopropylamine Oxide.

Cationic Surfactants

The inventive composition may additionally comprise one or more cationic surfactants (INCI Quaternary Ammonium Compounds), usually in an amount of from 0.001 to 5% by weight, preferably 0.01 to 4% by weight, more preferably 0.1 to 3% by weight, even more preferably 0.2 to 2% by weight, and most preferably 0.5 to 1.5% by weight, for example, 1% by weight.

In addition to the quaternary ammonium compounds (QAC) of formula I used as drying and shine additives, particularly preferred cationic surfactants are the quaternary, at times antimicrobially effective, ammonium compounds (QAC; INCI Quaternary Ammonium Compounds) according to the following general formula:

(R′)(R″)(R′″)(R^{IV})N⁺X⁻,

in which R′ to R^{IV} are identical or different C₁-C₂₂-alkyl radicals, C₇-C₂₀-aralkyl radicals or heterocyclic radicals, where two, or in the case of an aromatic incorporation, such as in pyridine, even three radicals, together with the nitrogen atom, form the heterocycle, e.g., a pyridinium or imidazolinium compound, and X⁻ is halide ions, sulfate ions, hydroxide ions or similar anions. For optimum antimicrobial action, at least one of the radicals preferably has a chain length of from 8 to 18, in particular 12 to 16, carbon atoms.

QACs can be prepared by reacting tertiary amines with alkylating agents, such as, for example, methyl chloride, benzyl chloride, dimethyl sulfate, and dodecyl bromide. Ethylene oxide may also be used in preparing the QACs. The alkylation of tertiary amines having one long alkyl radical and two methyl groups proceeds particularly readily, and the quaternization of tertiary amines having two long radicals and one methyl group can also be carried out using methyl chloride under mild conditions. Amines which have three long alkyl radicals or hydroxyl-substituted alkyl radicals are not very reactive and are preferably quaternized using dimethyl sulfate.

A particularly preferred QAC is cocoethoxymethylammonium methosulfate (INCI (PEG)_{X} Cocomonium Methosulfate; Rewoquat® CPEM) or homologs thereof where x=2 to 30, in particular 5 to 15, ethylene oxide units in the chain.

To avoid possible incompatibilities of the antimicrobial cationic surfactants with the anionic surfactants obtained according to the present invention, the cationic surfactant employed is as compatible as possible with anionic surfactants and/or is used in as small an amount as possible. In a particular embodiment of the present invention, antimicrobially effective cationic surfactants are dispensed with entirely. Antimicrobially effective substances which can be used include: parabens, benzoic acid and/or benzoate, lactic acid and/or lactates. Particular preference is given in the present invention to benzoic acid and/or lactic acid.

Solvents

The water content of the aqueous composition according to the invention is usually 20 to 99% by weight, preferably 40 to 90% by weight, in particular 50 to 85% by weight, particularly preferably 55 to 80% by weight. The water is added until a 100% by weight composition is obtained.

The composition of the present invention may also advantageously comprise one or more water-soluble organic solvents, usually in an amount of from 0.1 to 30% by weight, preferably 1 to 20% by weight, more preferably 2 to 15% by weight, even more preferably 4 to 12% by weight, and most preferably 6 to 10% by weight.

For the purposes of the present invention, the solvent is used as required, in particular in the form of a hydrotrope, viscosity regulator and/or low-temperature stabilizer. The solvent acts as a solubility promoter, in particular, for surfactants and electrolytes and also perfumes and dyes and thus contributes to their incorporation, prevents the formation of liquid crystalline phases and plays a part in the formation of clear products. The viscosity of the inventive composition decreases as the amount of solvent increases. However, too much solvent can bring about too great a reduction in the viscosity. Finally, as the amount of solvent increases, the low-temperature cloudpoint and clearpoint of the inventive composition decreases.

Suitable solvents include, for example: saturated or unsaturated, preferably saturated, branched or unbranched C₁₋₂₀-hydrocarbons, preferably C₂-C₁₈-hydrocarbons, having at least one hydroxyl group and optionally one or more ether functions C—O—C, i.e., oxygen atoms which interrupt the carbon atom chain.

Preferred solvents are C₂-C₆-alkylene glycols optionally etherified on one side with a C₁-C₆-alkanol, and poly-C₂-C₃-alkylene glycol ethers having, on average, 1 to 9 identical or different, preferably identical, alkylene glycol groups per molecule, and also C₁-C₆-alcohols, preferably ethanol, n-propanol or isopropanol, in particular ethanol.

Particularly preferred solvents are poly-C₂-C₃-alkylene glycol ethers etherified on one side with a C₁-C₆-alkanol and having, on average, 1 to 9, preferably 2 to 3, ethylene glycol or propylene glycol groups, for example PPG-2 methyl ether (dipropylene glycol monomethyl ether).

Especially preferred solvents are C₂-C₃-alcohols ethanol, n-propanol and/or isopropanol, in particular ethanol.

Apart from the above described solvents, solubility promoters which can be used, in particular for perfumes and dyes, may, for example, also be alkanolamines, and alkylbenzenesulfonates having 1 to 3 carbon atoms in the alkyl radical.

Additives

In addition to the quaternary ammonium compounds of the formula I added according to the present invention, the inventive composition may also comprise, to further improve the run-off and/or drying behavior, one or more additional additives which are selected from the group consiting of surfactants, polymers and builder substances (builders), usually in an amount of from 0.001 to 5% by weight, preferably 0.01 to 4% by weight, more preferably 0.1 to 3% by weight, even more preferably 0.2 to 2% by weight, and especially preferably 0.5 to 1.5% by weight, for example, 1% by weight.

Surfactants suitable, as additives, are essentially the amphoteric surfactants, anionic surfactants, nonionic surfactants and cationic surfactants already described above.

Polymers suitable, as additives, are, in particular, maleic acid-acrylic acid copolymer Na salt (Sokalan® CP 5), modified polyacrylic acid Na salt (Sokalan® CP 10), polyvinylpyrrolidone PVP and PVP N-oxide (Sokalan® HP 26), modified polycarboxylate Na salt (Sokalan® HP 25), polyalkylene oxide, modified heptamethyltrisiloxane (Silwet® L-77), polyalkylene oxide, modified heptamethyltrisiloxane (Silwet® L-7608), polyether siloxanes (copolymers of polymethylsiloxanes with ethylene oxide/propylene oxide segments (polyether blocks)), preferably water-soluble linear polyethersiloxanes with terminal polyether blocks, such as Tegopren® 5840, Tegopren® 5843, Tegopren® 5847, Tegopren® 5851, Tegopren® 5863, and Tegopren® 5878.

Builder substances suitable, as additives, are, in particular, polyaspartic acid Na salt, ethylenediaminetriacetate cocoalkylacetamide (Rewopol® CHT 12), methylglycinediacetic acid tri-Na salt (Trilon® ES 9964) and acetophosphonic acid (Turpinal® SL).

However, the use of silicone surfactants for application to hard surfaces made of glass, in particular glassware, is less preferred since these silicone surfactants can attach to glass. In the case of plastic ware, the use of silicone surfactants (e.g., TEGOPREN® 6950) leads to an optimized drying behavior (see, for example, U.S. Pat. No. 5,880,088).

Viscosity

The viscosity favorable for the inventive composition is, measured at 20° C. and a shear rate of 30 s⁻¹ using a Brookfield LV DV 11 viscosimeter and spindle 25, in the range from 10 to 5 000 mPa·s, preferably from 50 to 2 000 mPa·s, more perferably 100 to 1000 mPa·s, even more preferably 150 to 700 mPa·s, and most preferably 200 to 500 mPa·s, for example, 300 to 400 mPa·s.

The viscosity of the inventive composition can, particularly when the content of surfactant in the composition is low, be increased using inorganic salts or polymeric thickeners customary in this field, and/or, particularly when the content of surfactant in the composition is high, be reduced using solvents.

In a preferred embodiment of the present invention, the composition is, however, free from thickeners.

To stabilize the inventive composition, particularly when the surfactant content is high, it is possible to add one or more dicarboxylic acids and/or salts thereof, in particular a composition of Na salts of adipic, succinic and glutaric acid, as is obtainable, for example, under the trade name Sokalan® DSC. In this regard, the dicarboxylic acids and/or salts are used advantageously in amounts of from 0.1 to 8% by weight, preferably 0.5 to 7% by weight, more preferably 1.3 to 6% by weight and most preferably 2 to 4% by weight.

If, however, it is possible to dispense with the use thereof, then the composition according to the invention is preferably free from dicarboxylic acid (salts).

Auxiliaries and Additives

In addition, it is also possible for one or more further auxiliaries and additives customary in this field, in particular UV stabilizers, perfumes, dyes, bleaches (e.g., hydrogen peroxide), corrosion inhibitors, preservatives, and additives which improve the feel of the skin or care additives, may be present in amounts of usually not more than 5% by weight. To increase the performance, small amounts of enzymes can be used. Preference is given to proteases, amylases, lipases, peroxidases, gluconases, cellulases, mannases, etc., in amounts of from preferably 0.001 to 1.5% and particularly preferably less than 0.5%.

pH

The pH of the composition of the present invention may be adjusted by means of customary pH regulators, for example, acids, such as mineral acids or citric acid and/or alkalis, such as sodium hydroxide or potassium hydroxide, where, particularly if tolerability by the skin is desired, a range from 4 to 9, preferably 5 to 8, in particular 6 to 7, is preferred.

To establish and/or stabilize the pH, the composition of the present invention can comprise one or more buffer substances (INCI Buffering Agents), usually in amounts of from 0.001 to 5% by weight, preferably 0.005 to 3% by weight, more preferably 0.01 to 2% by weight, even more preferably 0.05 to 1% by weight, and most preferably 0.1 to 0.5% by weight, for example 0.2% by weight. Preference is given to buffer substances which are also complexing agents or even chelating agents (chelators, INCI Chelating Agents).

Particularly preferred buffer substances are citric acid and the citrates, in particular sodium and potassium citrates, for example, trisodiumcitrate.2H₂O and tripotassium citrate.H₂O.

Preparation

The inventive composition can be prepared by stirring together the individual constituents in any order. The order of mixing is not important for the preparation of the inventive composition.

In this regard, water, surfactants, the glycine compounds of formula (I) and optionally any of the additional ingredients mentioned above are preferably stirred together. If perfumes and/or dyes are used, then the perfumes and/or dyes are added to the resulting solution. The pH is then adjusted as described above.

The following examples are provided to demonstrate some of the advantages that may be obtained using the inventive composition as a hard surface cleaner.

### EXAMPLES

Compositions according to the present invention labled as A1-A7 in Table 1 and, for comparison, prior art commercially available hand dishwashing detergents labled as C1-C6 in Table 2 were prepared in accordance with the details above. The pH in each case was adjusted to a value of about 6.6.

TABLE 1

| Composition | | | | | | | |
|---|---|---|---|---|---|---|---|
| in % by weight | A1 | A2 | A3 | A4 | A5 | A6 | A7 |
| Na C₁₂-C₁₄-fatty alcohol + | 16 | 16 | 16 | 16 | 16 | 10 | 24 |
| 1.3 EO sulfate | | | | | | | |
| sec. Na C₁₂-C₁₆- | 8 | 8 | 8 | 8 | 8 | 20 | — |
| alkanesulfonate | | | | | | | |
| Cocamidoalkylbetaine | 8 | 8 | — | 2 | — | — | 2 |
| Cocoamphomonoacetate | 1 | 2 | 8 | 8 | 10 | 2 | 2 |
| Dimethylcocoalkyl | — | — | — | — | — | — | 2 |
| amine oxide | | | | | | | |
| C₉-C₁₃-Alcohol ethoxylate | — | — | — | — | — | — | 4 |
| Ethanol | 8 | 8 | 8 | 8 | 8 | 8 | 8 |
| Citric acid monohydrate | 0.2 | 0.2 | 0.2 | 0.2 | 0.2 | 0.2 | 0.2 |
| Water, perfume, dye, | Ad | ad | ad | ad | ad | ad | ad |
| auxiliaries | 100 | 100 | 100 | 100 | 100 | 100 | 100 |

TABLE 2

| Composition in % by weight | C1 | C2 | C3 | C4 | C5 | C6 |
|---|---|---|---|---|---|---|
| Na C₁₂-C₁₄-fatty alcohol + 1.3 EO | 16 | 16 | 16 | 10 | — | — |
| sulfate | | | | | | |
| Mg C₁₁-C₁₄-fatty alcohol + 1 EO | — | — | — | — | 13 | — |
| sulfate | | | | | | |
| Na C₁₁-C₁₄-fatty alcohol + 1 EO | — | — | — | — | 15 | — |
| sulfate | | | | | | |
| Na C₁₂-C₁₆-fatty alcohol + 2 EO | — | — | — | — | — | 6.3 |
| sulfate | | | | | | |
| sec. Na C₁₂-C₁₆-alkanesulfonate | 8 | 8 | 8 | 16 | — | 11.6 |
| Cocamidoalkylbetaine | 8 | 9 | 10 | 5 | — | — |
| Ethylbis(polyethoxy ethanol) Tallow | 2 | — | — | — | — | — |
| Ammonium Ethosulfate | | | | | | |
| Dimethylcocoalkylammoniumbetaine | — | — | — | — | 2.2 | — |
| N-Methyl-C₁₂-C₁₆-fatty acid | — | — | — | — | 1.3 | — |
| glucamide | | | | | | |
| Dimethylcocoalkcylamine oxide | — | — | — | — | 1.5 | — |
| C₉-C₁₃-Alcohol ethoxylate | — | — | — | — | 4.5 | 1 |
| Ethanol | 8 | 8 | 8 | 8 | 7 | — |
| Citric acid monohydrate | 0.2 | 0.2 | 0.2 | 0.2 | — | — |
| Water, perfume, dye, auxiliaries | ad | ad | ad | ad | ad | ad |
| | 100 | 100 | 100 | 100 | 100 | 100 |

Test Method

To test the drying rate, the decrease in weight of champagne flutes provided with outlet was monitored over time for all compositions. For this, the champagne flutes were initially filled with cleaning solution (wash liquor) and then rapidly emptied (within a few seconds) via the outlet. The run-off starts directly after the start of emptying. “Run-off” is the term used here to describe the beading-off of drops which remain adhering to the surface of the glass after the level of the liquid has been reduced. Run-off ends when the wash liquor layer on the surface of the glass has finally become so thin that it no longer runs off, but only decreases as a result of drying.

For the quantitative determination here, a balance was installed in an air-tight plastic box, and the weight decrease was measured via an interface with a computer for a period of 500 seconds in intervals of 10 seconds. In order to only determine the run-off, the first 10 seconds were not taken into consideration for the evaluation.

The champagne flutes were charged with the wash liquor heated to 20° C. or 40° C. The concentration was 0.2 g of cleaner per liter of wash liquor. The circular outlet inserted into the goblet of the champagne flute had a diameter of 15 mm and led away the draining wash liquor via the balance. Temperature and atmospheric humidity were monitored during the measurements using a hygrometer. For each wash liquor, 3×5 (15) measurements were carried out. In each case, an average was made of 15 measurements. For assessment, the drying rate and the residual moisture were determined.

Definition—Drying Rate

In order to compare the washing agents with regard to their drying behavior, the time taken to fall below the water value on untreated surfaces (=zero value, only wetted with tap water 6-8° German hardness) was evaluated. The times given in the tables indicate the time point at which the drying curves of pure water and the run-off curve of the surfactant solution intersect or achieve absolute dryness.

Definition—Residual Moisture

The amount of water which remains after run-off, i.e., after 500 seconds, and no longer runs off is referred to as residual moisture. Here too, the evaluation is shown in Tables 4 and 6.

Drying Behavior and Residue Behavior

Surfaces which have been treated with cleaners usually dry more slowly than untreated wetted surfaces since the water run-off is slowed by the adhering surfactant molecules. This too could be demonstrated in the measurement system used. Thus, all formulations gave, after a run-off time of 30 seconds, a residue of >200 mg of residual moisture, where as only <80 mg of residual moisture remained on the untreated surface. After these 30 seconds, moisture no longer runs off from the untreated surface, and drying starts by evaporation of the water.

As can be seen from the values given above, surfaces treated with surfactant exhibit delayed run-off behavior. In order to demonstrate the optimized drying behavior, the time at which the surface is drier compared to the untreated surface is recorded. This is intended to signify that the ware dries more quickly than is usually possible with water. The dishwashing detergents which have come onto the market recently have already been optimized in this respect. The dishwashing detergents according to the present invention exhibit, at 20° C., significantly better drying than the comparison products (C2-C6).

At 40° C., within the pregiven 500 seconds, the absolute dryness of the surfaces by tap water, and of the formulation according to the invention is achieved. The order of the drying rate is shown in Tables 3 and 5.

TABLE 3
Drying rate in the water comparison

| | | | | | | | | | | | | | | |
|---|---|---|---|---|---|---|---|---|---|---|---|---|---|---|
| Order | | | | | | | | | | | | | | |
| [>>] | A2 | A1 | A7 | A5 | C2 | C5 | A6 | C6 | A3 | A4 | C1 | C3 | H₂O | C4 |

| | | | | | | | | | |
|---|---|---|---|---|---|---|---|---|---|
| 20° C. | 290 | 295 | 355 | 365 | 450 | 475 | 500 | 500 | >500 |
| [s] | | | | | | | | | |

TABLE 4
Residual moisture after 500 seconds

| Order | | | | | | | | | | | | | | |
|---|---|---|---|---|---|---|---|---|---|---|---|---|---|---|
| [<<] | A2 | A1 | A7 | A5 | C2 | C5 | C6 | H₂O | A6 | A3 | A4 | C1 | C3 | C4 |
| 20° C. | 28 | 30 | 33 | 43 | 45 | 48 | 50 | 50 | 51 | 54 | 54 | 54 | 57 | 73 |
| [mg] | | | | | | | | | | | | | | |

TABLE 5
Drying rate to dryness

| | | | | | | | | | |
|---|---|---|---|---|---|---|---|---|---|
| Order [>>] | A2 | C1 | H₂O | C3 | C2 | C4 | C6 | C2 | A1 |

| | | | | |
|---|---|---|---|---|
| 40° C. [s] | 290 | 300 | 480 | >500 |

TABLE 6
Residual moisture after 500 seconds

| Order [<<] | A2 | C1 | H₂O | C3 | C2 | A1 | C6 | C4 | C5 |
|---|---|---|---|---|---|---|---|---|---|
| 40° C. [mg] | 0 | 0 | 0 | 1 | 6 | 11 | 24 | 25 | 26 |

As can be seen, the results demonstrate a significantly higher run-off rate, i.e., a more rapid run-off or a better run-off behavior, for the formulations according to the present invention than the formulations according to the known prior art.

Thus, the use of REWOTERIC® AM C both halves the drying rate and also the residual moisture compared with commercial products which have already been optimized. These surprising results were found primarily in the case of the addition of relatively small amounts, <5% by weight, of the glycinates according to the present invention to customary formulations.

At elevated temperature too, the formulation A2 is found to be the most rapid drying dishwashing detergent formulation. The use of REWOTERIC® AM C in dishwashing detergents increases the drying performance in the customary temperature ranges and at the same time the mildness of the overall formulation.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the spirit and scope of the appended claims.

What is claimed is:

1. A surfactant combination comprising:
(a) one or more alkyl ether sulfates; and
(b) at least one amphoteric interface-active glycine compound of general formula (I) 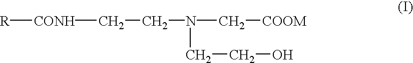
in which
R is an alkyl radical of a natural or synthetic monobasic fatty acid or a fatty acid mixture having 5 to 21 carbon atoms, and
M is hydrogen, ammonium, alkali metal or alkaline earth metal.

2. The surfactant combination of claim 1 further comprising:
(c) 0 to 50% of one or more alkylsulfonates, arylsulfonates or a combination thereof;
(d) 0 to 15% of one or more alkyl sulfates;
(f) 0 to 20% of one or more amphoteric surfactants; or any combination of components (c)-(f).

3. The surfactant combination of claim 1 wherein said alkyl radical of said natural or synthetic monobasic fatty acid or fatty acid mixture is branched.

4. The surfactant combination of claim 1 wherein said alkyl radical of said natural or synthetic monobasic fatty acid or fatty acid mixture contains multiple bonds.

5. An aqueous liquid composition, which comprises the surfactant combination of claim 1.

6. The composition of claim 5 wherein R of formula (I) is a C₇-C₁₇-alkyl radical.

7. The composition of claim 5 wherein M in formula (I) is K, Na, or ammonium.

8. The composition of claim 5 which further comprises one or more water-soluble organic solvents, one or more additives, one or more thickeners, one or more dicarboxylic acid salts, one or more auxiliaries and additives, or any combination thereof.

9. The composition of claim 5 wherein said composition has a viscosity of from 10 to 5000 mPa·s.

10. The composition of claim 5 wherein said composition has a viscosity of from 50 to 2000 mPa·s.

11. The composition of claim 5 wherein said composition has a viscosity of from 100 to 1000 mPa·s.

12. The composition of claim 5 wherein said composition has a viscosity of from 150 to 700 mPa·s.

13. The composition of claim 5 wherein said composition has a viscosity of from 200 to 500 mPa·s.

14. The composition of claim 5 wherein said composition has a pH of from 4 to 9.

15. The composition of claim 5 further comprising one or more buffer substances.

16. The composition of claim 15 wherein said one or more buffer substances comprise complexing or chelating buffer substances.

17. The composition of claim 16 wherein said complexing or chelating buffer substances comprise citric acid, citrates or combinations thereof.

18. A method for cleaning hard surfaces comprising applying an aqueous liquid composition to said hard surface, said aqueous liquid composition comprising at least a surfactant combination which comprises:
(a) one or more alkyl ether sulfates; and
(b) at least one amphoteric interface-active glycine compound of general formula (I) 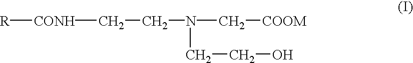
in which
R is an alkyl radical of a natural or synthetic monobasic fatty acid or a fatty acid mixture having 5 to 21 carbon atoms, and
M is hydrogen, ammonium, alkali metal or alkaline earth metal.

19. The method of claim 18 wherein said surfactant combination further comprises:
(c) 0 to 50% of one or more alkylsulfonates, arylsulfonates or a combination thereof;
(d) 0 to 15% of one or more alkyl sulfates;
(e) 0 to 20% of one or more amphoteric surfactants; or any combination of components (c)-(f).

20. The method of claim 18 wherein said hard surface is a dish, glassware, cutlery or any combination thereof.
